(19) United States
(12) Patent Application Publication
(10) Pub. No.: US 2008/0162578 A1
(43) Pub. Date: Jul. 3, 2008

(54) Management server performing communications with user terminals that access a web site

(75) Inventor: Hiroomi Shigematsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/987,781

(22) Filed: Dec. 4, 2007

(30) Foreign Application Priority Data
Dec. 27, 2006 (JP) JP2006-352735

(51) Int. Cl. G06F 17/30; G06F 15/16

(52) U.S. Cl. 707/104.1; 709/203; 707/E17.009

(57) ABSTRACT

A management server provides a Web site with a first user information input table and a second user information input table, accepts an input of the first user information input table from the user terminal of first user, stores first registration information containing the first user information inputted to the first user information input table and containing an identifying code for identifying the first user information, transmits, to the user terminal of the first user, the identifying code and address information of the second user information input table based on in-network identifying information contained in the first user information, accepts an input of the second user information input table from the user terminal of second user accessing the Web site by use of the address information, and stores second registration information containing the second user information inputted to the second user information input table and containing the identifying code.

This application claims the benefit of Japanese Patent Application No. 2006-352735 filed on Dec. 27, 2006 in the Japanese Patent Office, the disclosure of which is herein incorporated in its entirety by reference.

### BACKGROUND OF DISCLOSURE

The disclosure relates to management server performing communications with user terminals that access a WEB site.

With spread of the Internet over the recent years, users can make procedures of a variety of registrations in Web (World Wide Web). Such a case exists that the user employing the Internet desires for a predetermined exclusive service. This case entails registering individual information of the user at a registration site in the Web (World Wide Web) in order for the user to be provided with the predetermined exclusive service. Then, the individual information of the user is registered at the registration site, thereby registering the exclusive service.

[Patent document 1] Japanese Patent Application Laid-Open Publication No. 2002-024639

[Patent document 2] Japanese Patent Application Laid-Open Publication No. 2002-109378

[Patent document 3] Japanese Patent Application Laid-Open Publication No. 2002-133227

[Patent document 4] Japanese Patent Application Laid-Open Publication No. 2005-084756

There is a case where the user (introducer user) provided with the predetermined exclusive service wants, he or she thinks, to introduce the predetermined exclusive service to acquaintance users (introduced users). For making a record that the introducer user has introduced the exclusive service to the introduced user at the registration site, it is required that the introducer user provides the individual information of the introduced user to the registration site. This case raises a problem that the individual information of the introduced user is provided to the registration site defined as a third party without any consent of the introduced user. Another problem arises, wherein the introducer user deals with individual information of others.

### SUMMARY

The disclosure aims at preventing the individual information of the introduced user from being provided to the registration site without any consent of the introduced user.

The disclosure adopts the following means in order to solve the problems. Namely, according to the disclosure, a management server establishing a Web site in a network and performing communications with user terminals that access the Web site, comprises: an accepting unit providing the Web site with a first user information input table for registering user information of a first user and a second user information input table for registering user information of a second user, and accepting an input of the first user information input table from the user terminal of the first user; a storage unit stored with first registration information containing the first user information inputted to the first user information input table and containing an identifying code for identifying the first user information; and a transmitting unit transmitting, to the user terminal of the first user, the identifying code and address information of the second user information input table provided at the Web site based on in-network identifying information contained in the first user information, wherein the accepting unit accepts an input of the second user information input table from the user terminal of the second user accessing the Web site by use of the address information, and the storage unit is stored with second registration information containing the second user information inputted to the second user information input table and containing the identifying code.

In the management server according to the disclosure, the storage unit is stored with the first registration information containing the first user information and containing the identifying code and with the second registration information containing the second user information and containing the identifying code. Then, the first user information and the second user information are associated with each other by use of the identifying codes stored in the storage unit. Therefore, the first user information and the second user information can be associated with each other without inputting the second user information to the first user information input table. Further, the first user information and the second user information can be associated with each other without inputting the first user information to the second user information input table.

Furthermore, the management server according to the disclosure may further comprise a management unit managing the first registration information and the second registration information stored in the storage unit in a way that associates the first registration information and the second registration information with each other by use of the identifying code. The management server according to the disclosure enables the management of the first registration information and the second registration information that are stored in the storage unit in the way of their being associated with each other by employing the identifying codes.

According to the disclosure, a management server establishing a Web site in a network and performing communications with user terminals that access the Web site, comprises: an accepting unit providing the Web site with a first user information input table for registering user information of a first user, and accepting an input of the first user information input table from the user terminal of the first user; a storage unit stored with first registration information containing the first user information inputted to the first user information input table and containing an identifying code for identifying the first user information; a transmitting unit transmitting, to the user terminal of the first user, the identifying code and a source program for generating a second user information input table based on in-network identifying information contained in the first user information; and a receiving unit receiving second registration information containing user information of a second user that is inputted to the second user information input table generated based on the source program and containing the identifying code, wherein the storage unit is stored with the second registration information.

In the management server according to the disclosure, the storage unit is stored with the first registration information containing the first user information and containing the identifying code and with the second registration information containing the second user information and containing the identifying code. Then, the first user information and the second user information are associated with each other by use of the identifying codes stored in the storage unit. Therefore, the first user information and the second user information can be associated with each other without inputting the second user information to the first user information input table. Further, the first user information and the second user information can be associated with each other without inputting the first user information to the second user information input table.

Furthermore, the management server according to the disclosure may further comprise a management unit managing the first registration information and the second registration information stored in the storage unit in a way that associates the first registration information and the second registration information with each other by use of the identifying code. The management server according to the disclosure enables the management of the first registration information and the second registration information that are stored in the storage unit in the way of their being associated with each other by employing the identifying codes.

Further, the disclosure may also be a method by which a computer, other devices, machines, etc execute any one of the processes described above. Still further, the disclosure may also be a program for making the computer, other devices, machines, etc realize any one of the functions described above. Yet further, the disclosure may also be a recording medium recorded with such a program, which can be read by the computer etc.

According to the disclosure, the individual information of the introduced user can be prevented from being provided to the registration site without any consent of the introduced user.

### BRIEF DESCRIPTION OF THE DRAWINGS

FIG. 1 is a block diagram showing a system architecture in the present embodiment.

FIG. 2 is a function block diagram of a management server 103.

FIG. 3 is a diagram showing a hardware configuration of the management server 103.

FIG. 4 is a diagram showing a processing flow of the system according to a first embodiment.

FIG. 5 is an explanatory diagram showing how a registration site is accessed and how an exclusive service is registered.

FIG. 6 is a diagram showing an input example of an individual information input page 514.

FIG. 7 is a diagram showing an example of a sentence for notifying of completion of the registration of the exclusive service for an introducer user and an example of a notice of a campaign for the exclusive service, which are described in a body of a completion-of-registration mail.

FIG. 8 is a diagram showing an example of the sentence for notifying of the completion of the registration of the exclusive service for the introducer user and an example of the notice of the campaign for the exclusive service, which are described in the body of the completion-of-registration mail.

FIG. 9 is an explanatory diagram showing how the registration site is accessed and how the exclusive service is registered.

FIG. 10 is a diagram showing an example of a case of displaying an individual information input page 914 on a monitor screen of a user terminal 102.

FIG. 11 is a diagram showing an example of a case of displaying a check page 915 on the monitor screen of the user terminal 102.

FIG. 12 is an explanatory diagram in the case of outputting in the CSV format individual information of an introduced user that is inputted to the individual information input page 914.

FIG. 13 is a flowchart showing a processing flow of the system according to a second embodiment.

FIG. 14 is an explanatory diagram showing how the registration site is accessed and how the exclusive service is registered.

FIG. 15 is a diagram showing an input example of the individual information input page 514.

FIG. 16 is a diagram showing a display example of an HTML mail displayed on a monitor screen of a user terminal 101.

FIG. 17 is a diagram showing an example of an introduction mail generated in an HTML format.

### DETAILED DESCRIPTION

Embodiments of the disclosure will hereinafter be described with reference to the drawings. Configurations in the following embodiments are exemplifications, and the disclosure is not limited to the configurations in the embodiments.

### First Embodiment

### <System Architecture>

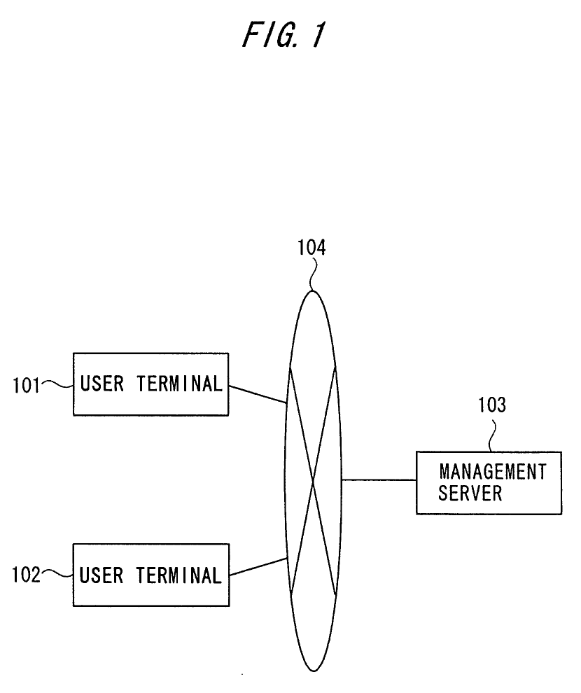

FIG. 1 is a block diagram illustrating the system architecture in the first embodiment. The system includes a user terminal 101, a user terminal 102 and a management server 103. The user terminal 101 and the management server 103 exchange information with each other via a network 104. Further, the user terminal 102 and the management server 103 exchange the information with each other via the network 104. The management server 103 provides a Web site (registration site) for registering a user who is provided with an exclusive service.

Each of the user terminal 101 and the user terminal 102 includes a CPU (Central Processing Unit), a ROM (Read Only Memory), a RAM (Random Access Memory), an external storage device, a communication interface, a display device such as a monitor and a display, and an input device such as a keyboard and a mouse, and is defined as a computer accessible to the network 104. This type of computer is broadly known in terms of its configuration and operation as a personal computer, and hence its explanation is omitted.

Further, in addition to the user terminal 101 and the user terminal 102, it is feasible to employ information processing devices connectable to the network 104, such as a PDA (Personal Digital Assistant), a mobile phone and CE (Consumer Electronics) equipment.

An introducer user inputs information (individual information about the introducer user) on a screen of a monitor provided in the user terminal 101, thus registering the user. Herein, the introducer user operates the user terminal 101, thereby accessing the registration site and displaying a Web page for inputting the individual information on the screen of the monitor provided in the user terminal 101. Then, the introducer user inputs the individual information of the introducer user via the user terminal 101. To be specific, the introducer user operates the user terminal 101, thereby accessing the registration site opened by the management server 103 via the network 104 and registering the individual information. In the first embodiment, the Internet can be employed as the network 104. Further, in addition, the network 104 can be built up by communication lines such as telephone lines, private lines, an optical communication network and a communication satellite.

The user terminal 101 includes a WWW (World Wide Web) Browser (which will hereinafter simply be termed the Browser). The user terminal 101 is accessible to the site opened in the network 104 where the Browser is used. The site opened in the network 104 is specified by a unique URL (Uniform Resource Locator). The Browser gets accessible to the site opened in the network 104 by designating the URL. Moreover, when inputting a specific URL to the Browser, the Browser becomes connectable to a server that configures the site specified by the URL in a way that uses a protocol described in the URL. The URL is organized by a protocol for accessing the information existing in the network 104, a name of the server in the network 104 where the information exists, a directory stored with the information and a file name. The URL corresponds to address information according to the disclosure.

Moreover, the Browser can receive a desired file described in the URL from the management server 103. The Browser, after receiving the file, decodes the received file. Then, the Browser displays a screen defined by the file on the monitor of the user terminal 101. The file is described in a markup language such as HTML (Hypertext Markup Language) and XML (Extensible Markup Language). Further, the Browser can also transmit the information inputted by the introducer user to the connected management server 103.

The user terminal 101 includes a mailer. The user terminal 101 receives an electronic mail and an HTML mail delivered from the management server 103 by use of the mailer.

The registration site opened by the management server 103 is specified by the unique URL. The user terminal 101 designates the URL of the registration site opened by the management server 103 in a way that employs the Browser, whereby the user terminal 101 can access the management server 103.

The user terminal 102 also has the same functions as the user terminal 101 has. Therefore, an introduced user performs the same operation as the introducer user does, whereby the user terminal 102 can exchange various items of information with the management server 103.

The management server 103 has a Web server function. The management server 103 provides the Web site in the network 104, and accepts the accesses from the user terminal 101 and the user terminal 102.

The site opened by the management server 103 entails setting access numbers for identifying the individual information of the introducer user and the introduced user. The access number may also be a set of numerals, alphabets and other symbols. The individual information corresponds to user information according to the disclosure. Further, the access number corresponds to an identification code according to the disclosure.

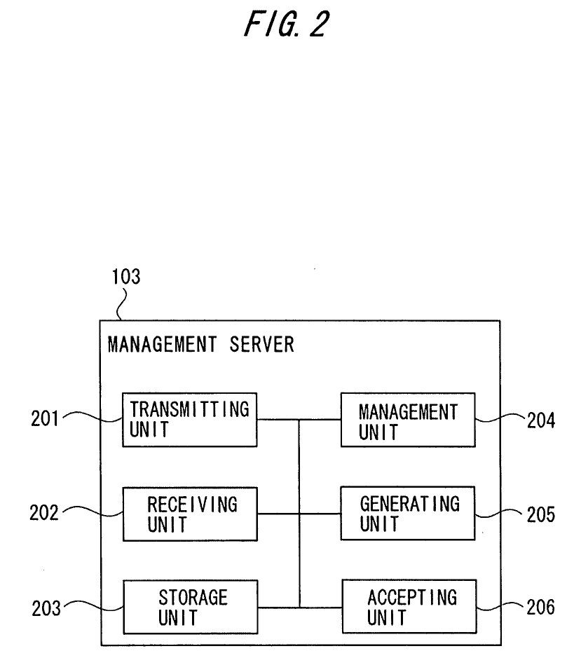

FIG. 2 is a function block diagram of the management server 103. The management server 103 includes a transmitting unit 201, a receiving unit 202, a storage unit 203, a management unit 204, a generating unit 205 and an accepting unit 206.

The transmitting unit 201 transmits the various items of information to the user terminal 101 and the user terminal 102 via the network 104. The receiving unit 202 receives the various items of information from the user terminal 101 and the user terminal 102 via the network 104.

The storage unit 203 is stored with the various items of information. The storage unit 203 includes a database stored with the individual information. The management unit 204 controls the operation of the whole management server 103. The generating unit 205 generates an e-mail such as a completion-of-registration mail and an introduction mail.

The accepting unit 206 provides the Web site in the network 104 and accepts the accesses from the user terminal 101 and the user terminal 102.

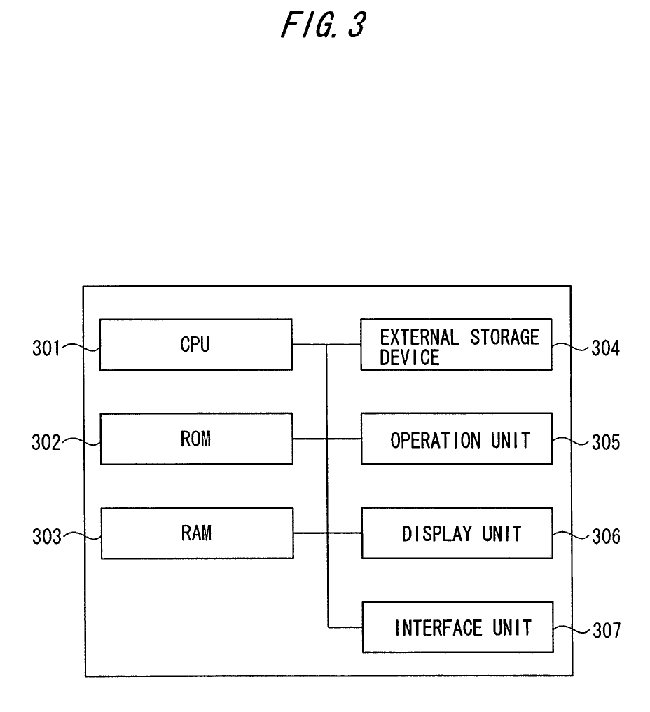

FIG. 3 is a diagram showing a hardware architecture of the management server 103. The management server 103 is constructed of a CPU (Central Processing Unit) 301, a ROM (Read Only Memory) 302, a RAM (Random Access Memory) 303, an external storage device 304, an operation unit 305, a display unit 306 and an interface unit 307. These components are connected to each other via a bus.

The CPU 301 executes a variety of processes according to a program stored in the ROM 302. The CPU 301 establishes communication lines with the user terminal 101 and the user terminal 102 via the interface unit 307. The CPU 301 reads a Web server program stored in the ROM 302, whereby the management server 103 functions as the Web server. The interface unit 307 includes communication devices such as a MODEM and a terminal adaptor, and controls the communications with the user terminal 101 and the user terminal 102.

The ROM 302 is stored with, e.g., a communication program for establishing and maintaining the communications with the user terminal 101 and the user terminal 102. Further, the ROM 302 is stored with OS (Operating System) for realizing the file input and output and the control of the management server 103. Moreover, the ROM 302 is stored with a program and parameters needed for the management server 103 to function. The RAM 303 is stored with data required for the CPU 301 to operate and with an application program executed by the CPU 301. The external storage device 304 controls reading and writing from and to a hard disk (unillustrated) stored with the application program and the necessary data. The operation unit 305 is exemplified by a keyboard and a mouse and is operated when inputting a predetermined command and the necessary data. The display unit 306 includes a display device such as a CRT (Cathode Ray Tube), a liquid crystal display and a plasma display, and an output device such as a sound output device like a loudspeaker, and a printer device.

### Processing Flow of System in First Embodiment

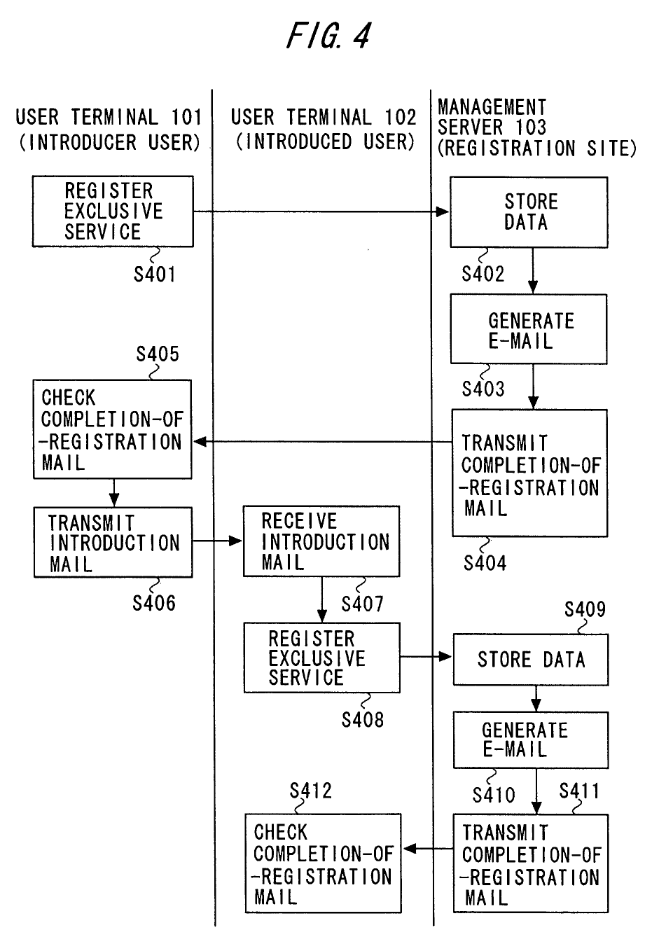

FIG. 4 shows a processing flow of the system according to the first embodiment. The introducer user accesses the registration site of the management server 103 by operating the user terminal 101. Then, the introducer user inputs the individual information of the introducer user at the registration site of the management server 103, thus registering the individual information (S401). It follows that the exclusive service is registered by registering the individual information of the introducer user at the registration site of the management server 103.

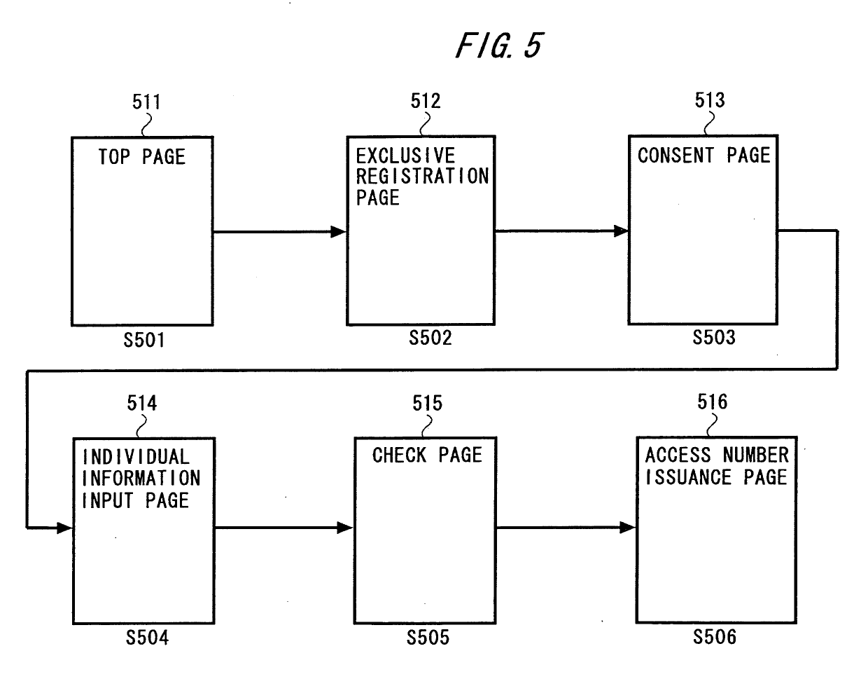

The access to the registration site and the registration of the exclusive service are specifically described with reference to FIG. 5. To start with, the introducer user accesses the registration site by operating the user terminal 101. For instance, the introducer user accesses the registration site by inputting the URL of the registration site to the Browser provided in the user terminal 101 (S501).

When the introducer user accesses the registration site by operating the user terminal 101, a top page 511 is displayed on the monitor screen of the user terminal 101. The top page 511 is a Web page displayed, when the registration site is accessed, at first on the monitor screen of the user terminal 101.

The introducer user makes, in a way that operates the user terminal 101, transition to an exclusive registration page 512 from the top page 511 on the monitor screen of the user terminal 101 (S502). The exclusive registration page 512 is a Web page on which contents of the exclusive service are described. The introducer user browses the exclusive registration page 512 and thus confirms the contents of the exclusive service. Thereafter, the introducer user makes, by operating the user terminal 101, the transition to a consent page 513 from the exclusive registration page 512 on the monitor screen of the user terminal 101 (S503). The consent page 513 is a Web page on which contents of the consent to the exclusive service are described.

The introducer user confirms the contents of the consent to the exclusive service by browsing the consent page 513. Thereafter, the introducer user makes, by operating the user terminal 101, the transition to an individual information input page 514 from the consent page 513 on the monitor screen of the user terminal 101 (S504). The individual information input page 514 is a Web page on which a registration form for inputting the individual information of the introducer user is described.

The introducer user inputs, by operating the user terminal 101, items of individual information of the introducer user such as a name of a corporation, a name of a user, an address, a telephone number and an e-mail address to the individual information input page 514.

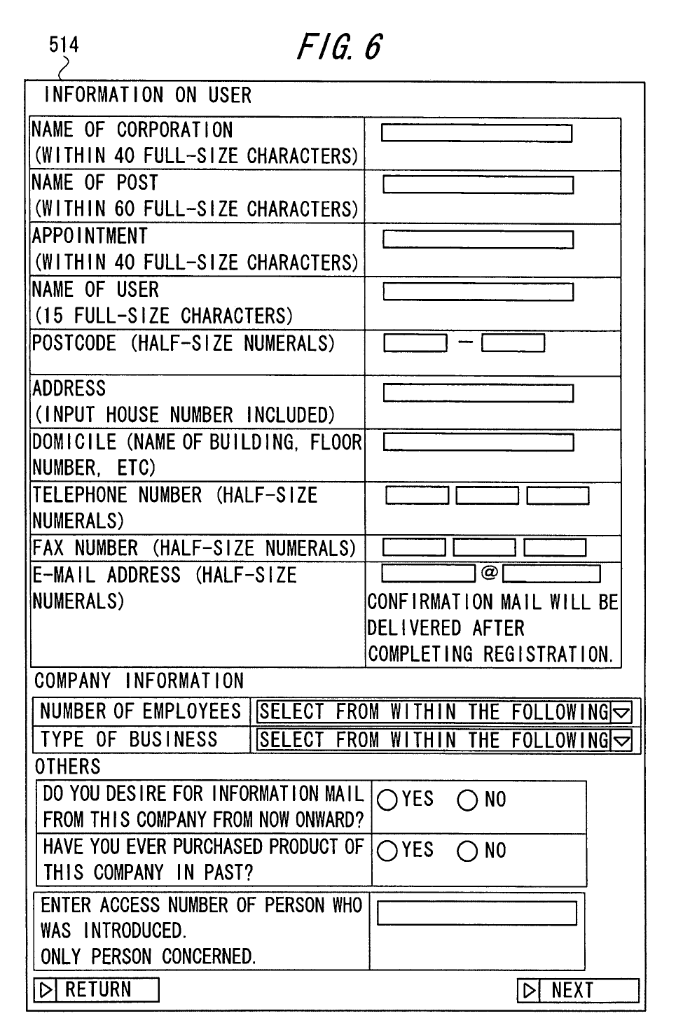

FIG. 6 shows an input example of the individual information input page 514. As illustrated in FIG. 6, the individual information of the introducer user contains a name of a corporation, a name of a post, an appointment, a name of a user, a postcode, an address, a domicile (a name of a building, a floor number, etc), a telephone number, a fax number, an e-mail address, a number of employees, a type of business, a desire/non-desire for a company information mail, a purchase/non-purchase of a product of the company and an access number of the person who was introduced.

In this case, if there is a user who introduced the registration site, the access number of the user who introduced the registration site is entered in a box of [ENTER ACCESS NUMBER OF PERSON WHO WAS INTRODUCED. ONLY PERSON CONCERNED.] on the individual information input page 514. If there is no user who introduced the registration site, nothing is entered in the box of [ENTER ACCESS NUMBER OF PERSON WHO WAS INTRODUCED. ONLY PERSON CONCERNED.].

The introducer user makes, by operating the user terminal 101, the transition to a check page 515 from the individual information input page 514 on the monitor screen of the user terminal 101 (S505). The check page 515 is a Web page on which to check the individual information of the introducer user that is inputted to the individual information input page 514. For example, when the introducer user presses a [NEXT] button on the individual information input page 514, the individual information input page 514 displayed on the monitor screen of the user terminal 101 is changed over to the check page 515.

The introducer user browses the check page 515 and checks the individual information of the introducer user, which is inputted to the individual information input page 514. Then, the introducer user makes the transition to an access number issuance page 516 from the check page 515 by operating the user terminal 101 (S506). The access number issuance page 516 is a Web page for notifying the introducer user of an access number of the introducer user. For instance, when the introducer user presses the [NEXT] button on the check page 515, the exclusive registration page displayed on the monitor screen of the user terminal 101 is changed over to the access number issuance page 516.

The check page 515 transits to the access number issuance page 516, wherein the exclusive service of the introducer user is registered.

Next, the management server 103 stores the storage unit 203 with the individual information of the introducer user that is inputted to the individual information input page 514 (S402). The process of storing the storage unit 203 with the individual information of the introducer user is triggered by the process that the introducer user makes the transition to the access number issuance page 516 from the check page 515 by operating the user terminal 101. In the case of storing the individual information of the introducer user in the storage unit 203, the individual information of the introducer user that is inputted to the individual information input page 514, is output in a CSV (Comma-Separated Values) format.

Then, the management server 103 generates a completion-of-registration mail notifying of a purport that the registration of the exclusive service has been completed (S403). Specifically, the generating unit 205 generates the completion-of-registration mail. In this case, the generating unit 205 generates the completion-of-registration mail in a text format. A body of the completion-of-registration mail contains a description of a sentence for informing of the completion of the registration of the exclusive service of the introducer user and a description of a notice of a campaign for the exclusive service.

An administrator or a data operator of the management server 103 previously creates the sentence for notifying of the completion of the registration of the exclusive service for the introducer user and the notice of the campaign for the exclusive service. The storage unit 203 is stored with the sentence for notifying of the completion of the registration of the exclusive service for the introducer user and the notice of the campaign for the exclusive service, which are created by the administrator or the data operator of the management server 103. The generating unit 205 generates the completion-of-registration mail by describing the sentence for notifying of the completion of the registration of the exclusive service for the introducer user and the notice of the campaign for the exclusive service in the body of the completion-of-registration mail. Then, the generating unit 205 describes the e-mail address of the introducer user, which is registered in the storage unit 203, in a header of the completion-of-registration mail.

Next, the management server 103 sends the completion-of-registration mail to the user terminal 101 (S404). To be specific, the transmitting unit 201 transmits the completion-of-registration mail.

Then, the user terminal 101 receives the completion-of-registration mail sent from the management server 103 via the network 104. The introducer user checks the sentence for notifying of the completion of the registration of the exclusive service for the introducer user and the notice of the campaign for the exclusive service, which are described in the body of the completion-of-registration mail, by use of the mailer provided in the user terminal 101 (S405).

If the completion-of-registration mail contains the notice of the campaign for the exclusive service, the introducer user informs a friend as an introduced user of the exclusive service (S406). Specifically, the introducer user, by operating the user terminal 101, copies the notice of the campaign of the exclusive service that is described in the body of the completion-of-registration mail, and pastes the copied notice of the campaign of the exclusive service to the body of the e-mail (introduction mail). Then, the introducer user transmits the introduction mail to the user terminal 102 by operating the user terminal 101.

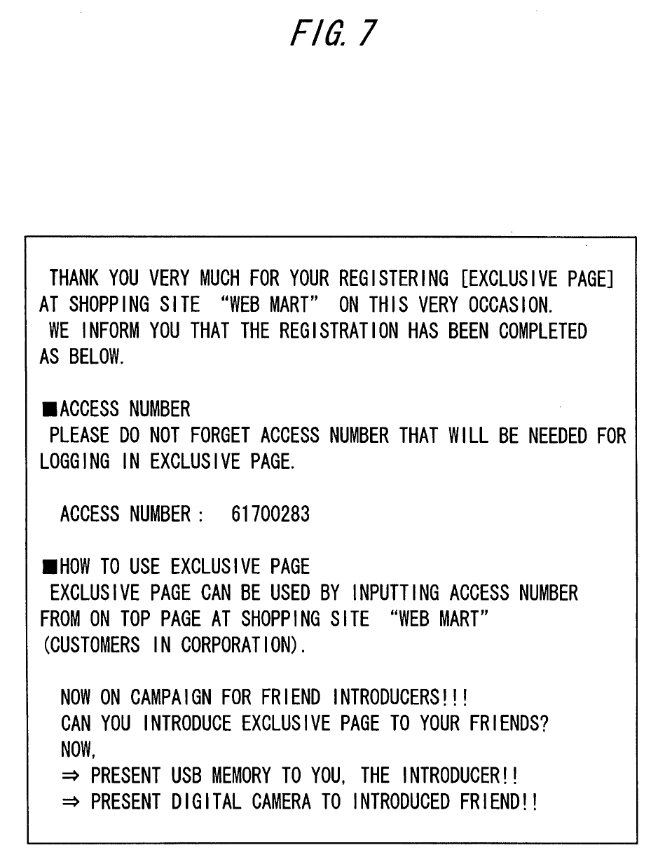

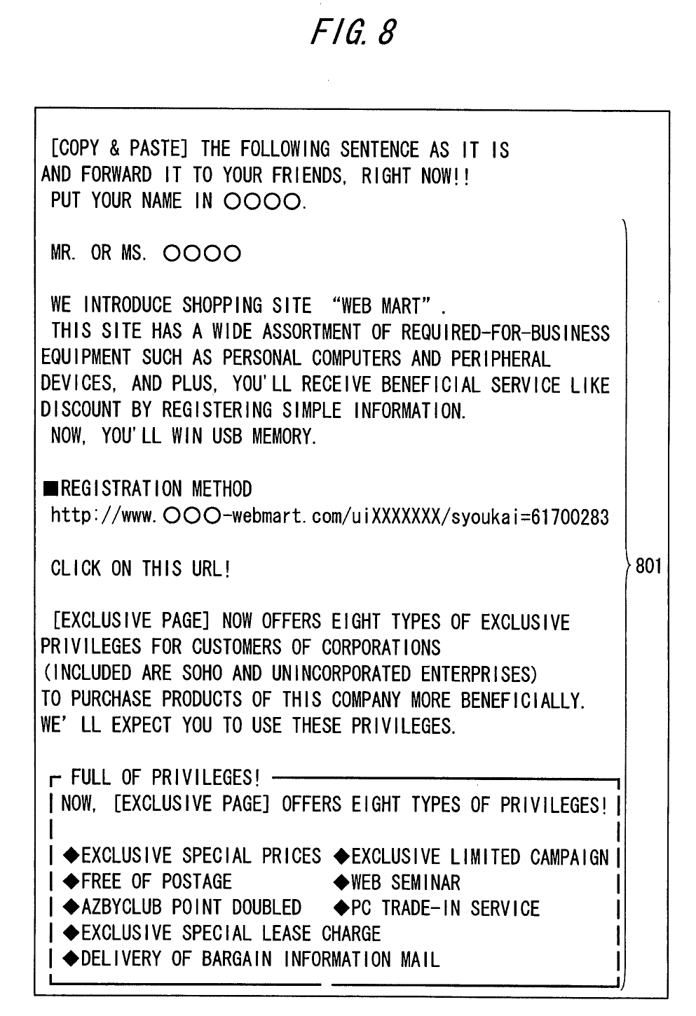

FIGS. 7 and 8 illustrate examples of the sentence for notifying of the completion of the registration of the exclusive service for the introducer user and the notice of the campaign for the exclusive service, which are described in the body of the completion-of-registration mail. The body of the completion-of-registration mail contains the description of the sentence for notifying of the completion of the registration of the exclusive service for the introducer user and the description of the notice of the campaign for the exclusive service, which are illustrated in FIGS. 7 and 8. For example, the introducer user pastes an introduction notice 801 in FIG. 8 to the body of the introduction mail by operating the user terminal 101.

The user terminal 102 receives the introduction mail via the network 104 (S407). The URL is, as illustrated in FIG. 8, described in the body of the introduction mail. The introduced user browses the body of the introduction mail and, if desiring to be provided with the exclusive service, clicks the URL described in the body of the introduction mail. To be specific, the introduced user browses the body of the introduction mail by use of the mailer provided in the user terminal 102. Then, the introduced user inputs the URL described in the body of the introduction mail displayed on the monitor screen of the user terminal 102 to the Browser of the user terminal 102 by operating the input device provided in the user terminal 102.

When the URL described in the body of the introduction mail is inputted to the Browser of the user terminal 102, a Web page for inputting the individual information onto the monitor screen of the user terminal 102, is displayed. To be specific, the Browser of the user terminal 102 accesses the registration site by use of the URL containing the access number of the introducer user.

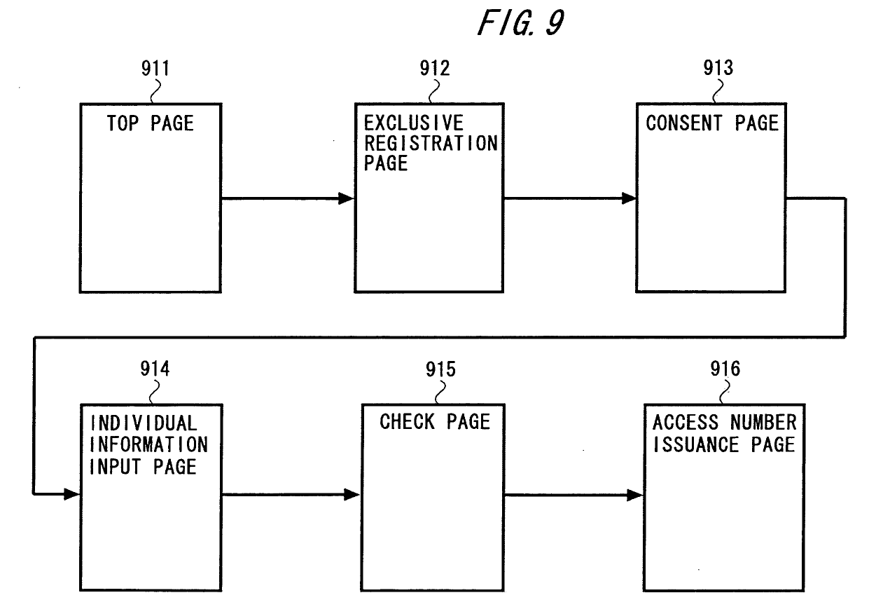

A specific explanation of how the registration site is accessed and how the exclusive service is registered will be made with reference to FIG. 9. To begin with, the introduced user browses an exclusive registration page 912, and checks contents of the exclusive service. The exclusive registration page 912 is a Web page on which contents of the exclusive service are described. Thereafter, the introduced user makes, by operating the user terminal 102, the transition to a consent page 913 from the exclusive registration page 912 on the monitor screen of the user terminal 102. The consent page 913 is a Web page on which the contents of the consent to the exclusive service are described.

The introduced user browses the consent page 913 and checks the contents of the consent to the exclusive service. Thereafter, the introduced user makes, by operating the user terminal 102, the transition to an individual information input page 914 from the consent page 913 on the monitor screen of the user terminal 102. The individual information input page 914 is a Web page on which a registration form for inputting the individual information of the introduced user is described.

The introduced user inputs, by operating the user terminal 102, items of individual information of the introduced user such as a name of a corporation, a name of a user, an address, a telephone number and an e-mail address to the individual information input page 914.

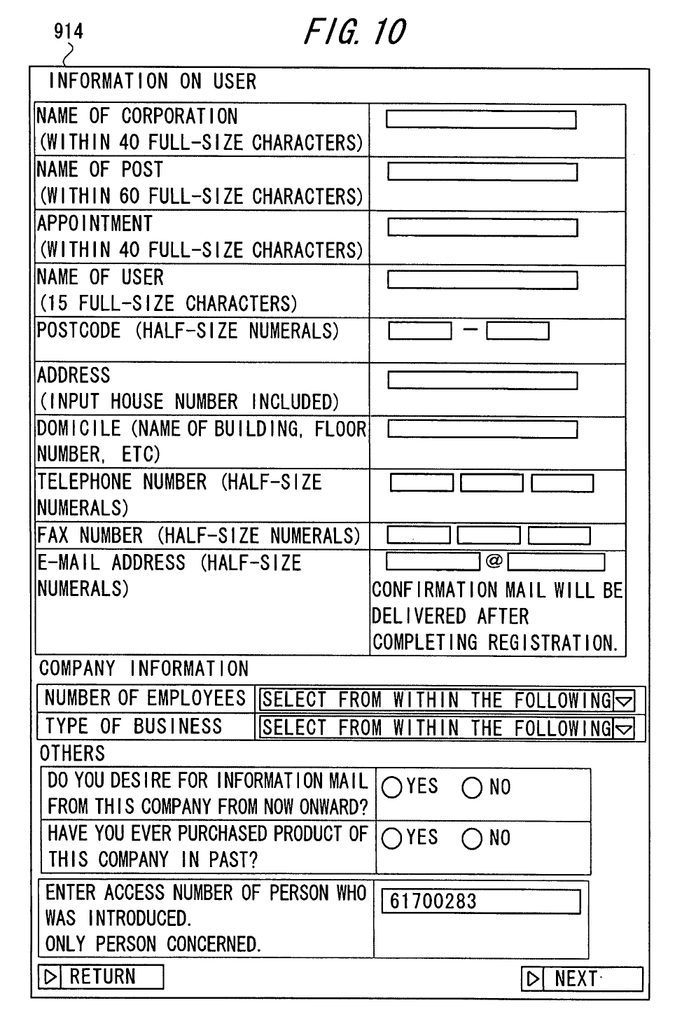

FIG. 10 shows an example of a case where the individual information input page 914 is displayed on the monitor screen of the user terminal 102. A box of [ENTER ACCESS NUMBER OF PERSON WHO WAS INTRODUCED. ONLY PERSON CONCERNED.] on the individual information input page 914 displayed on the monitor screen of the user terminal 102, is in a status where the access number of the introducer user is entered. Therefore, the introduced user has no necessity of entering the access number of the introducer user on the monitor screen of the user terminal 102 that displays the individual information input page 914.

The introduced user makes, by operating the user terminal 102, the transition to a check page 915 from the individual information input page 914. The check page 915 is a Web page on which to check the individual information of the introduced user that is inputted to the individual information input page 914. For example, when the introduced user presses the [NEXT] button on the individual information input page 914, the individual information input page 914 displayed on the monitor screen of the user terminal 102 is changed over to the check page 915.

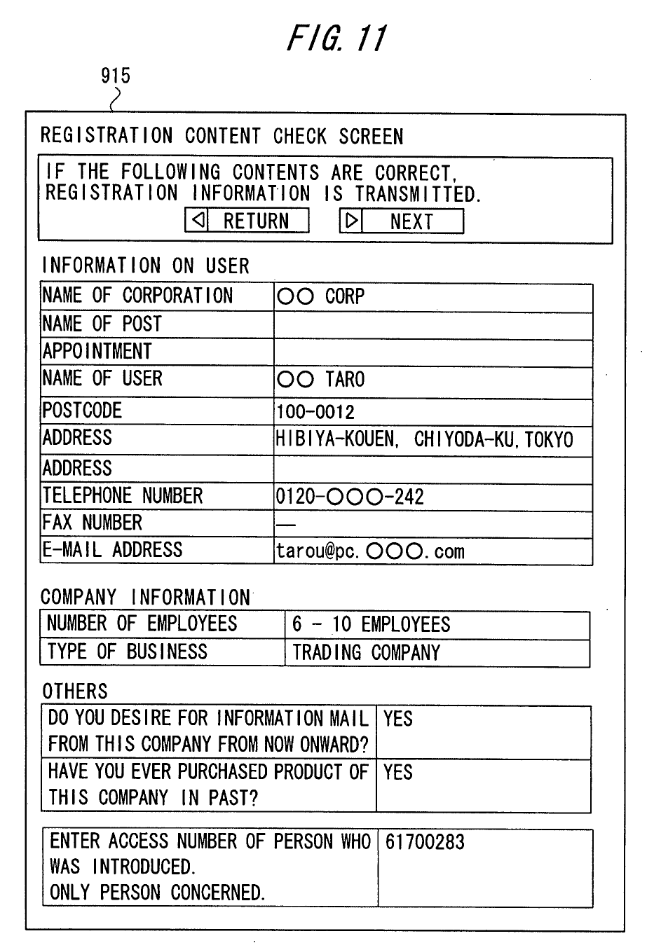

FIG. 11 shows an example of a case where the check page 915 is displayed on the monitor screen of the user terminal 102. A box of [ENTER ACCESS NUMBER OF PERSON WHO WAS INTRODUCED. ONLY PERSON CONCERNED.] on the check page 915 displayed on the monitor screen of the user terminal 102, contains an entry of the access number of the introducer user.

The introduced user browses the check page 915 and checks the individual information of the introduced user that is inputted to the individual information input page 914. Then, the introduced user makes, by operating the user terminal 102, the transition to an access number issuance page 916 from the check page 915. The access number issuance page 916 is a Web page for notifying the introduced user of the access number of the introduced user. For instance, when the introduced user presses the [NEXT] button on the check page 915, the exclusive registration page displayed on the monitor screen of the user terminal 102 is changed over to the access number issuance page 916.

The check page 915 transits to the access number issuance page 916, wherein the exclusive service of the introduced user is registered (S408).

The management server 103 stores the storage unit 203 with the individual information of the introduced user that is inputted to the individual information input page 914 (S409). The process of storing the storage unit 203 with the individual information of the introduced user is triggered by the process that the introduced user makes the transition to the access number issuance page 916 from the check page 915 by operating the user terminal 102.

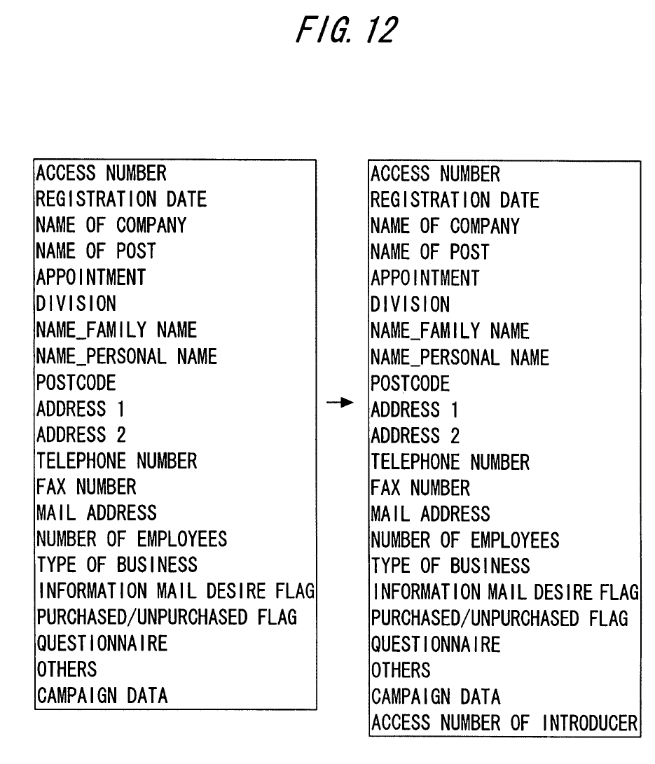

In the case of storing the individual information of the introduced user in the storage unit 203, the individual information of the introduced user that is inputted to the individual information input page 914, is output in the CSV (Comma-Separated Values) format. As illustrated in FIG. 12, in the case of outputting in the CSV format the individual information of the introduced user that is inputted to the individual information input page 914, the access number of the introducer is described at the tail of the output items of the CSV.

Then, the management server 103 generates a completion-of-registration mail notifying of a purport that the registration of the exclusive service has been completed (S410). Specifically, the generating unit 205 generates the completion-of-registration mail. In this case, the generating unit 205 generates the completion-of-registration mail in the text format. A body of the completion-of-registration mail contains a description of a sentence for informing of the completion of the registration of the exclusive service of the introduced user and a description of a notice of a campaign for the exclusive service.

The administrator or the data operator of the management server 103 previously creates the sentence for notifying of the completion of the registration of the exclusive service for the introduced user and the notice of the campaign for the exclusive service. The storage unit 203 is stored with the sentence for notifying of the completion of the registration of the exclusive service for the introduced user and the notice of the campaign for the exclusive service, which are created by the administrator or the data operator of the management server 103. The generating unit 205 generates the completion-of-registration mail by describing the sentence for notifying of the completion of the registration of the exclusive service for the introduced user and the notice of the campaign for the exclusive service in the body of the completion-of-registration mail. Then, the generating unit 205 describes the e-mail address of the introduced user, which is registered in the storage unit 203, in the header of the completion-of-registration mail.

Next, the management server 103 sends the completion-of-registration mail to the user terminal 102 (S411). To be specific, the transmitting unit 201 transmits the completion-of-registration mail.

Then, the user terminal 102 receives the completion-of-registration mail sent from the management server 103 via the network 104. The introduced user checks the sentence for notifying of the completion of the registration of the exclusive service for the introduced user and the notice of the campaign for the exclusive service, which are described in the body of the completion-of-registration mail, by use of the mailer provided in the user terminal 102 (S412).

The introduced user checks the notice of the campaign for the exclusive service that is described in the body of the completion-of-registration mail, and can notify other users of the notice of the campaign for the exclusive service that is described in the body of the completion-of-registration mail.

When the introducer user registers the exclusive service (when the introducer user registers the individual information of the introducer user at the registration site), the storage unit 203 gets stored with the access number of the introducer user together with the individual information of the introducer user. Further, when the introduced user registers the exclusive service (when the introduced user registers the individual information of the introduced user at the registration site), the storage unit 203 gets stored with the access number of the introducer user together with the individual information of the introduced user.

The management unit 204 extracts, from the storage unit 203, the introducer user coincident with a value of the access number of the introducer user and the introduced user coincident with the value of the access number of the introducer. The management unit 204 extracts the introducer user coincident with the value of the access number of the introducer user and the introduced user coincident with the value of the access number of the introducer, thereby detecting, as a parent-child relationship, the introducer user and the introduced user who was introduced by the introducer user and made the registration of the exclusive service. The management unit 204 conducts the management in a way that associates the introducer user with the introduced user introduced by the introducer user as the parent-child relationship.

According to the first embodiment, the access number of the introducer user is inputted to the registration form of the exclusive service for the introduced user, and hence a record that the exclusive service was introduced to the introduced user by the introducer user, is made at the registration site. Namely, the management unit 204 can manage the introducer user and the introduced user as the parent-child relationship according to the access number of the introducer user. Therefore, the introducer user has no necessity of inputting the individual information of the introduced user to the registration form of the exclusive service for the introducer user. As a result, it is possible to prevent the individual information of the introduced user from being provided to the registration site without any consent of the introduced user.

Moreover, according to the first embodiment, the access number of the introducer user is inputted to the registration form of the exclusive service for the introduced user. Therefore, the introduced user has, when registering the exclusive service, no necessity of inputting the access number of the introducer user to the registration form of the exclusive service for the introduced user. As a result, when the introduced user registers the exclusive service, it is feasible to prevent a mis-input and non-input of the access number of the introducer user. Further, it is possible for the introduced user to save a labor for inputting the information (e.g., the name of the introducer user) for specifying the introducer user to the registration form of the exclusive service for the introduced user. Further, the non-input of the access number of the introducer user is prevented, and therefore the introducer user can inevitably receive a special privilege given to the introducer user owing to the completion of registering the exclusive service for the introduced user.

Moreover, according to the first embodiment, the management unit 204 manages the introducer user and the introduced user introduced by the introducer user in a way that associates the introducer user and the introduced user as the parent-child relationship. As a result, the administrator or the data operator of the management server 103 can give the special privileges owing to the friend registration campaign to the introducer user and to the introduced user managed by the management unit 204.

### Second Embodiment

### The first embodiment has exemplified the system in which the user terminal 102 receives the introduction mail containing the description of the notice of the campaign for the exclusive service.

A second embodiment will exemplify a system, wherein the user terminal 101 generates the exclusive registration page 912, the consent page 913 and the individual information input page 914, and the exclusive registration page 912, the consent page 913 and the individual information input page 914 are transmitted to the user terminal 102. The mailer provided in the user terminal 101 in the second embodiment includes an HTML mail generating function.

Other configurations and operations are the same as those in the first embodiment. Such being the case, the same components are marked with the same numerals and symbols as those in the first embodiment, and their explanations are omitted. Further, the drawings in FIGS. 1 through 12 are referred to when the necessity may arise.

### Processing Flow in Second Embodiment

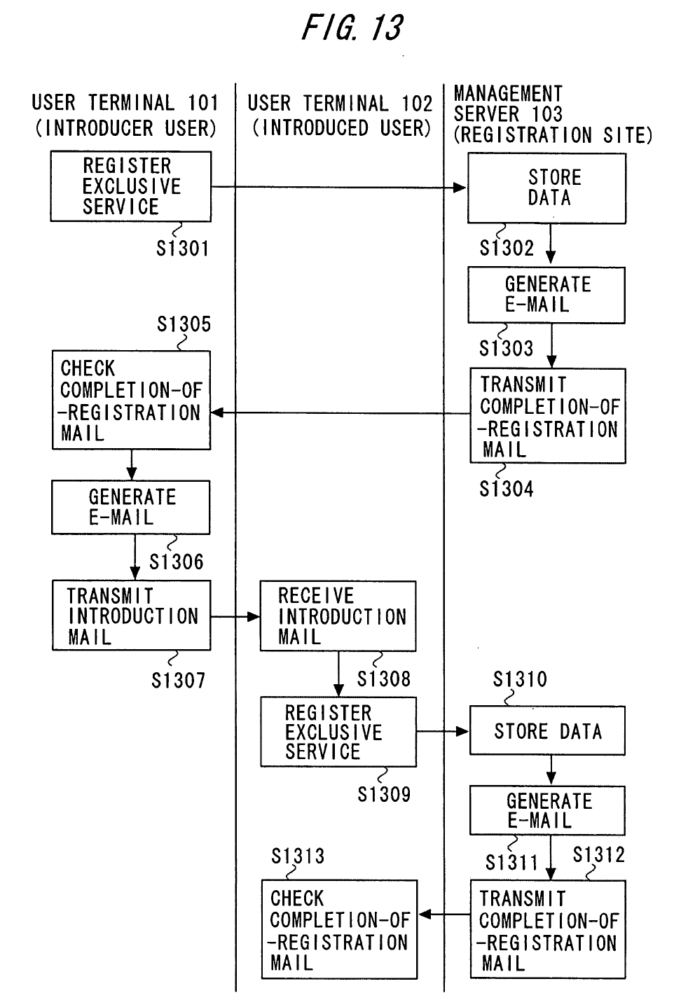

FIG. 13 shows a processing flow of the system according to the second embodiment. The introducer user accesses the registration site of the management server 103 by operating the user terminal 101. Then, the introducer user, at the registration site of the management server 103, inputs the individual information of the introducer user and registers the exclusive service (S1301).

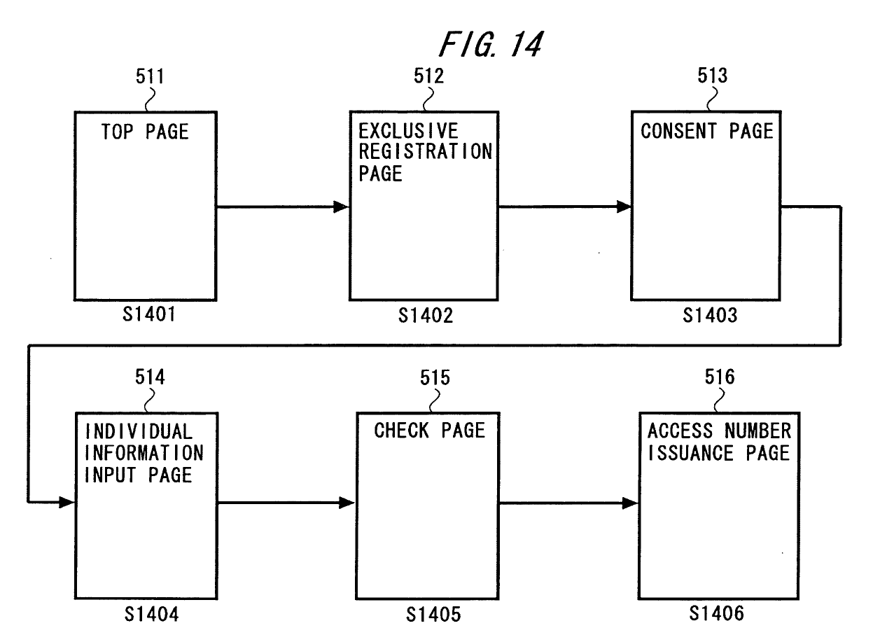

A specific explanation of how the registration site is accessed and how the exclusive service is registered will be made with reference to FIG. 14.

To begin with, the introducer user accesses the registration site by operating the user terminal 101. For example, the introducer user accesses the registration site by inputting the URL of the registration site to the Browser provided in the user terminal 101 (S1401).

When the introducer user accesses the registration site by operating the user terminal 101, the top page 511 is displayed on the monitor screen of the user terminal 101. The top page 511 is a Web page displayed at first on the monitor screen of the user terminal 101.

The introducer user makes, by operating the user terminal 101, the transition to the exclusive registration page 512 from the top page 511 on the monitor screen of the user terminal 101 (S1402). The introducer user checks the contents of the exclusive service by browsing the exclusive registration page 512. Thereafter, the introducer user makes, by operating the user terminal 101, the transition to the consent page 513 from the exclusive registration page 512 on the monitor screen of the user terminal 101 (S1403).

The introducer user checks the contents of the consent by browsing the consent page 513. Thereafter, the introducer user makes, by operating the user terminal 101, the transition to the individual information input page 514 from the consent page 513 on the monitor screen of the user terminal 101 (S1404).

The introducer user inputs, by operating the user terminal 101, items of individual information of the introducer user such as a name of a corporation, a name of a user, an address, a telephone number and an e-mail address to the individual information input page 514.

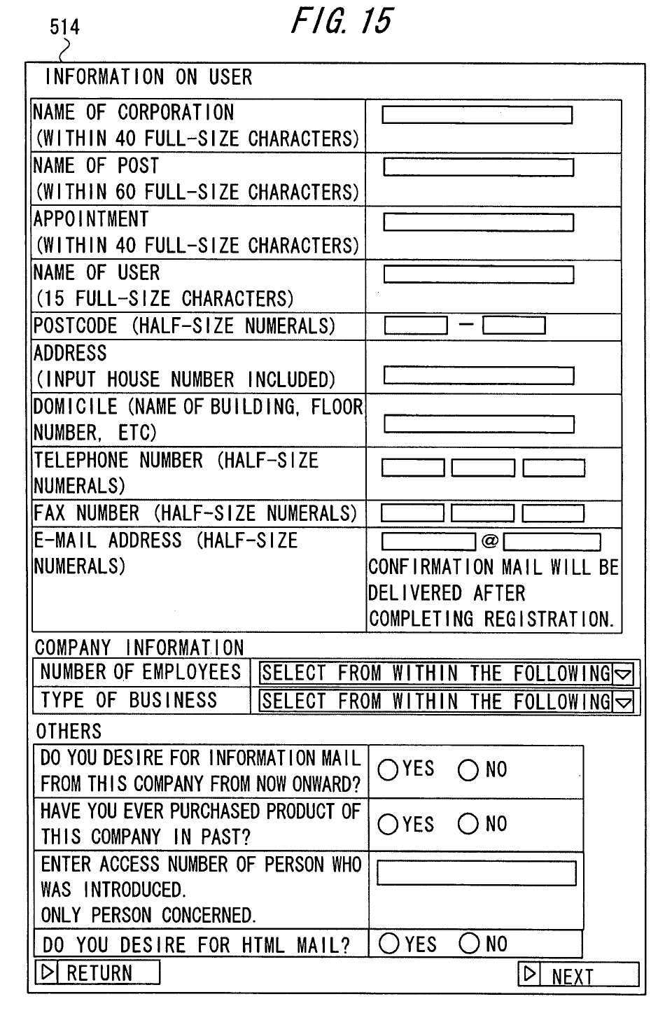

FIG. 15 shows an input example of the individual information input page 514. As illustrated in FIG. 15, the individual information of the introducer user contains a name of a corporation, a name of a post, an appointment, a name of a user, a postcode, an address, a domicile (a name of a building, a floor number), a telephone number, a Fax number, an e-mail address, a number of employees, a type of business, a desire/non-desire for a company information mail, a purchase/non-purchase of a product of the company, required or unrequired reception of the HTML mail and an access number of the person who was introduced.

The introducer user, if desiring to receive the HTML mail, checkmarks an HTML mail reception-enabled checkbox on the individual information input page 514. For instance, the introducer user, by operating the user terminal 101, checkmarks [YES] in the box of [DO YOU DESIRE FOR HTML MAIL?] on the individual information input page 514 illustrated in FIG. 15.

Further, if there is a user who introduced the registration site, the access number of the user who introduced the registration site is entered in a box of [ENTER ACCESS NUMBER OF THE PERSON WHO WAS INTRODUCED. ONLY PERSON CONCERNED.] on the individual information input page 514. If there is no user who introduced the registration site, nothing is entered in the box of [ENTER ACCESS NUMBER OF THE PERSON WHO WAS INTRODUCED. ONLY PERSON CONCERNED.].

The introducer user makes, by operating the user terminal 101, the transition to the check page 515 from the individual information input page 514 (S1405). For example, when the introducer user presses the [NEXT] button on the individual information input page 514, the individual information input page 514 displayed on the monitor screen of the user terminal 101 is changed over to the check page 515.

The introducer user checks the individual information of the introducer user that is inputted to the individual information input page 514 by browsing the check page 515. Then, the introducer user makes, by operating the user terminal 101, the transition to the access number issuance page 516 from the check page 515 (S1406). For example, when the introducer user presses the [NEXT] button on the check page 515, the exclusive registration page displayed on the monitor screen of the user terminal 101 is changed over to the access number issuance page 516.

The check page 515 transits to the access number issuance page 516, wherein the exclusive service for the introducer user is registered.

Next, the management server 103 stores the storage unit 203 with the individual information of the introducer user that is inputted to the individual information input page 514 (S1302). The process of storing the storage unit 203 with the individual information of the introducer user is triggered by the process that the introducer user makes the transition to the access number issuance page 516 from the check page 515 by operating the user terminal 101.

In the case of storing the storage unit 203 with the individual information of the introducer user, the individual information of the introducer user, which is inputted to the individual information input page 514, is output in the CSV format.

Then, the management server 103 generates the completion-of-registration mail notifying of a purport that the registration of the exclusive service has been completed (S1303). Specifically, the management unit 204 refers to a box of the required or unrequired reception of HTML mail that is inputted to the individual information input page 514. Then, if “required” is entered in the box of the required or unrequired reception of HTML mail that is inputted to the individual information input page 514, the management unit 204 instructs the generating unit 205 to generate the completion-of-registration mail in the HTML format. Whereas if “unrequired” is entered in the box of the required or unrequired reception of HTML mail that is inputted to the individual information input page 514, the management unit 204 instructs the generating unit 205 to generate the completion-of-registration mail in the text format. The generating unit 205 receiving the instruction from the management unit 204 generates the completion-of-registration mail.

Herein, if the completion-of-registration mail is the e-mail in the text format, a processing sequence in S1303 through S1313 in FIG. 13 is carried out according to the processing sequence in S403 through S412 in FIG. 4 which has been explained in the first embodiment. Hence, if the completion-of-registration mail is the e-mail in the text format, this case has been described in the first embodiment, and its explanation is therefore omitted.

By contrast, if the completion-of-registration mail is the HTML mail, the body of the completion-of-registration mail contains a description of the sentence for notifying of the completion of the registration of the exclusive service for the introducer user, a description of the notice of the campaign for the exclusive service and a description of a generation button.

The administrator or the data operator of the management server 103 previously creates the sentence for notifying of the completion of the registration of the exclusive service for the introducer user and the notice of the campaign for the exclusive service. The storage unit 203 is stored with the sentence for notifying of the completion of the registration of the exclusive service for the introducer user and the notice of the campaign for the exclusive service, which are created by the administrator or the data operator of the management server 103. The generating unit 205 generates the completion-of-registration mail by describing the sentence for notifying of the completion of the registration of the exclusive service for the introducer user, the notice of the campaign for the exclusive service and the generating button in the body of the completion-of-registration mail. Then, the generating unit 205 describes the e-mail address of the introducer user, which is registered in the storage unit 203, in the header of the completion-of-registration mail.

Next, the management server 103 sends the completion-of-registration mail to the user terminal 101 (S1304). To be specific, the transmitting unit 201 transmits the completion-of-registration mail.

Then, the user terminal 101 receives the completion-of-registration mail sent from the management server 103 via the network 104. The introducer user checks the sentence for notifying of the completion of the registration of the exclusive service for the introducer user and the notice of the campaign for the exclusive service, which are described in the body of the completion-of-registration mail, by use of the mailer provided in the user terminal 101 (S1305).

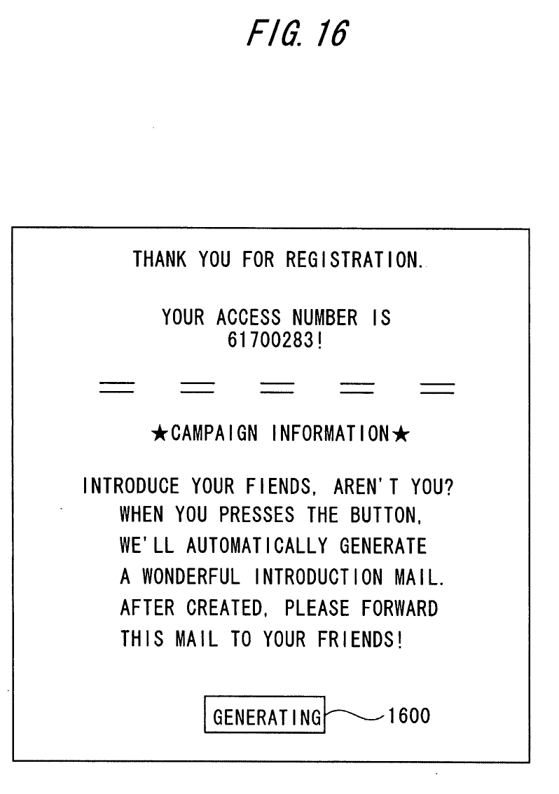

Next, the introducer user generates the introduction mail by employing the mailer provided in the user terminal 101 (S1306). FIG. 16 shows a display example of the HTML mail displayed on the monitor screen of the user terminal 101 when the user terminal 101 receives the completion-of-registration mail in the HTML mail format. The introducer user presses, by operating the user terminal 101, a generating button 1600 provided in the body of the HTML mail displayed on the monitor screen of the user terminal 101.

When pressing the generating button 1600, the introduction mail in the HTML format is generated. Namely, the mailer of the user terminal 101 generates the HTML mail of which the body contains descriptions of the exclusive registration page 912, the consent page 913 and the individual information input page 914. For instance, a source program for generating the exclusive registration page 912, the consent page 913 and the individual information input page 914 is embedded in the generating button 1600. Then, the mailer of the user terminal 101 generates, based on the source program embedded in the generating button 1600, the HTML mail containing the descriptions of the exclusive registration page 912, the consent page 913 and the individual information input page 914 in the body of the HTML mail.

The introducer user describes, by operating the user terminal 101, a mail address of the terminal of the introduced user in the header of the introduction mail generated in the HTML format. The introducer user transmits the introduction mail to the user terminal 102 by operating the user terminal 101 (S1307).

The user terminal 102 receives the introduction mail via the network 104 (S1308). The introduced user browses the exclusive registration page 912, the consent page 913 and the individual information input page 914, which are described in the body of the introduction mail, by employing the mailer of the user terminal 102.

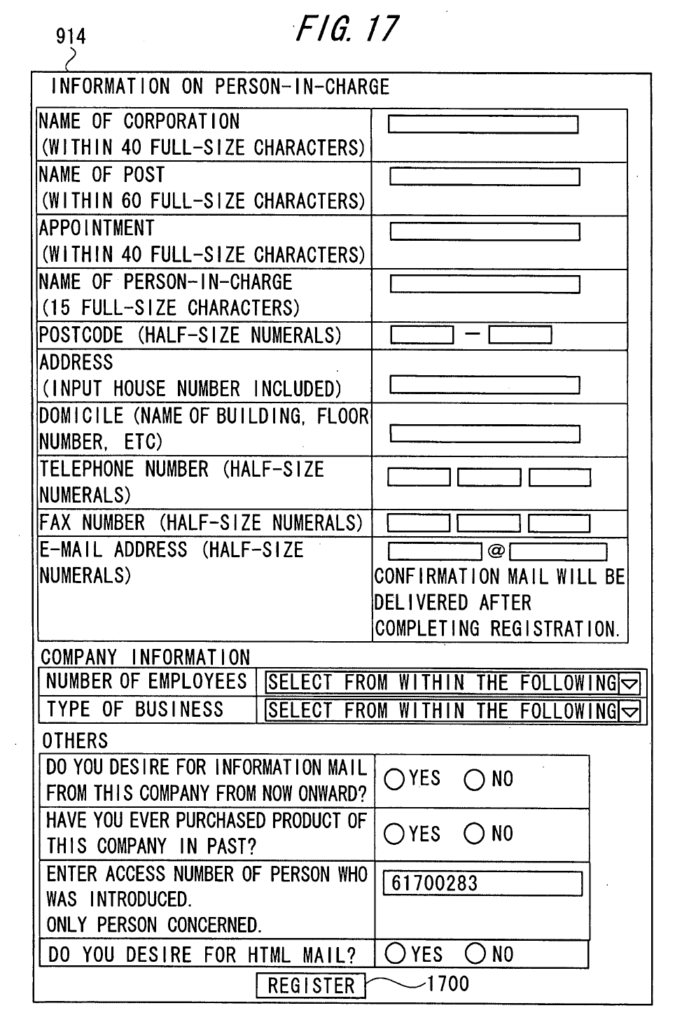

FIG. 17 illustrates an example of the introduction mail generated in the HTML format. As illustrated in FIG. 17, a registration button 1700 is provided in the body of the introduction mail. The introduced user, if desiring to register the exclusive service, inputs the individual information of the introduced user to the individual information input page 914 and presses the registration button 1700 provided in the body of the introduction mail by operating the user terminal 102.

When the registration button 1700 provided in the body of the HTML mail is pressed, the individual information of the introduced user, which is inputted to the individual information input page 914, is transmitted to the management server 103. Specifically, the Browser of the user terminal 102 transmits the individual information of the introduced user, which is inputted to the individual information input page 914, to the management server 103. In this case, the individual information of the introduced user may be encrypted.

Further, when the registration button 1700 provided in the body of the HTML mail is pressed, the individual information input page 914, to which the individual information of the introduced user is inputted, may also be transmitted to the management server 103. In this case, the mailer of the user terminal 102 sends the individual information input page 914, to which the individual information of the introduced user is inputted, to the management server 103. In this instance, the individual information input page 914, to which the individual information of the introduced user is inputted, may be encrypted.

When the management server 103 receives the individual information of the introduced user that is inputted to the individual information input page 914, the exclusive service for the introduced user is registered (S1309).

When the introducer user registers the exclusive service (when the introducer user registers the individual information of the introducer user at the registration site), the storage unit 203 is stored with the access number of the introducer user together with the individual information of the introducer user (S1310). Further, when the introduced user registers the exclusive service (when the introduced user registers the individual information of the introduced user at the registration site), the storage unit 203 is stored with the access number of the introducer user together with the individual information of the introduced user. A processing sequence in S1311 through S1313 in FIG. 13 is carried out according to the processing sequence in S410 through S412 in FIG. 4 which has been explained in the first embodiment. Hence, this case has been described in the first embodiment, and its explanation is therefore omitted.

The management unit 204 extracts, from the storage unit 203, the introducer user coincident with a value of the access number of the introducer user and the introduced user coincident with the value of the access number of the introducer. The management unit 204 extracts the introducer user coincident with the value of the access number of the introducer user and the introduced user coincident with the value of the access number of the introducer, thereby detecting, as a parent-child relationship, the introducer user and the introduced user who was introduced by the introducer user and made the registration of the exclusive server. The management unit 204 conducts the management in a way that associates the introducer user with the introduced user introduced by the introducer user as the parent-child relationship.

According to the second embodiment, the access number of the introducer user is inputted to the registration form of the exclusive service for the introduced user, and hence a record that the exclusive service was introduced to the introduced user by the introducer user, is made at the registration site. Namely, the management unit 204 can manage the introducer user and the introduced user as the parent-child relationship according to the access number of the introducer user. Therefore, the introducer user has no necessity of inputting the individual information of the introduced user to the registration form of the exclusive service for the introducer user. As a result, it is possible to prevent the individual information of the introduced user from being provided to the registration site without any consent of the introduced user.

Moreover, according to the second embodiment, the access number of the introducer user is inputted to the registration form of the exclusive service for the introduced user. Therefore, the introduced user has, when registering the exclusive service, no necessity of inputting the access number of the introducer user to the registration form of the exclusive service for the introduced user. As a result, when the introduced user registers the exclusive service, it is feasible to prevent a mis-input and non-input of the access number of the introducer user. Further, it is possible for the introduced user to save a labor for inputting the information (e.g., the name of the introducer user) for specifying the introducer user to the registration form of the exclusive service for the introduced user. Further, the non-input of the access number of the introducer user is prevented, and therefore the introducer user can inevitably receive a special privilege given to the introducer user owing to the completion of registering the exclusive service for the introduced user.

Moreover, according to the second embodiment, the management unit 204 manages the introducer user and the introduced user introduced by the introducer user in a way that associates the introducer user and the introduced user as the parent-child relationship. As a result, the administrator or the data operator of the management server 103 can give the special privileges owing to the friend registration campaign to the introducer user and to the introduced user managed by the management unit 204.

### Modified Example

The first embodiment has exemplified the scheme, wherein the management server 103 transmits the completion-of-registration mail containing the description of the notice of the campaign for the exclusive service in the body of the completion-of-registration mail, to the user terminal 101 and the user terminal 102. Further, the second embodiment has exemplified the scheme, wherein the management server 103 transmits the completion-of-registration mail containing the description of the notice of the campaign for the exclusive service and the description of the generating button 1600 in the body of the completion-of-registration mail, to the user terminal 101 and the user terminal 102.

The implementation of the disclosure is not limited to the embodiments discussed above. Namely, the present modified example has a scheme that a management server 203 may transmit an exclusive mail containing the description of the notice of the campaign for the exclusive service in the body of the exclusive mail to the user terminal 101 of the introducer user who registered the exclusive service and to the user terminal 102 of the introduced user who registered the exclusive service. Moreover, the present modified example has another scheme that the management server 203 may transmit the exclusive mail containing the description of the notice of the campaign for the exclusive service and the description of the generating button 1600 in the body of the exclusive mail to the user terminal 101 of the introducer user who registered the exclusive service and to the user terminal 102 of the introduced user who registered the exclusive service.

According to the present modified example, other than when registering the exclusive service for the introducer user and the introduced user, the introducer user and the introduced user can notify the friend users of the notice of the campaign for the exclusive service.

### <Readable-by-Computer Recording Medium>

A program for making a computer realize any one of the functions described above can be recorded on a readable-by-computer recording medium. Then, the computer is made to read and execute the program on this recording medium, whereby the function thereof can be provided. Herein, the readable-by-computer recording medium connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc are given as those demountable from the computer. Further, a hard disc, a ROM, etc are given as the recording mediums fixed within the computer.

What is claimed is:

1. A management server establishing a Web site in a network and performing communications with user terminals that access the Web site, comprising:
an accepting unit providing the Web site with a first user information input table for registering user information of a first user and a second user information input table for registering user information of a second user, and accepting an input of the first user information input table from said user terminal of the first user;
a storage unit stored with first registration information containing the first user information inputted to the first user information input table and containing an identifying code for identifying the first user information; and
a transmitting unit transmitting, to the user terminal of the first user, the identifying code and address information of the second user information input table provided at the Web site based on in-network identifying information contained in the first user information,
wherein said accepting unit accepts an input of the second user information input table from said user terminal of the second user accessing the Web site by use of the address information, and
said storage unit is stored with second registration information containing the second user information inputted to the second user information input table and containing the identifying code.

2. The management server according to claim 1, further comprising a management unit managing the first registration information and the second registration information stored in said storage unit in a way that associates the first registration information and the second registration information with each other by use of the identifying code.

3. A management server establishing a Web site in a network and performing communications with user terminals that access the Web site, comprising:
an accepting unit providing the Web site with a first user information input table for registering user information of a first user, and accepting an input of the first user information input table from said user terminal of the first user;
a storage unit stored with first registration information containing the first user information inputted to the first user information input table and containing an identifying code for identifying the first user information;
a transmitting unit transmitting, to the user terminal of the first user, the identifying code and a source program for generating a second user information input table based on in-network identifying information contained in the first user information; and
a receiving unit receiving second registration information containing user information of a second user that is inputted to the second user information input table generated based on the source program and containing the identifying code,
wherein said storage unit is stored with the second registration information.

4. The management server according to claim 3, further comprising a management unit managing the first registration information and the second registration information stored in said storage unit in a way that associates the first registration information and the second registration information with each other by use of the identifying code.

5. A management method executed by a management server establishing a Web site in a network and performing communications with user terminals that access the Web site, said method comprising:
an accepting step of providing the Web site with a first user information input table for registering user information of a first user and a second user information input table for registering user information of a second user, and accepting an input of the first user information input table from said user terminal of the first user;
a storing step of storing a storage unit with first registration information containing the first user information inputted to the first user information input table and containing an identifying code for identifying the first user information; and
a transmitting step of transmitting, to the user terminal of the first user, the identifying code and address information of the second user information input table provided at the Web site based on in-network identifying information contained in the first user information,
wherein said accepting step includes accepting an input of the second user information input table from said user terminal of the second user accessing the Web site by use of the address information, and
said storing step includes storing said storage unit with second registration information containing the second user information inputted to the second user information input table and containing the identifying code.

6. The management method according to claim 5, further comprising a managing step of managing the first registration information and the second registration information stored in said storage unit in a way that associates the first registration information and the second registration information with each other by use of the identifying code.

7. A management method executed by a management server establishing a Web site in a network and performing communications with user terminals that access the Web site, comprising:
an accepting step of providing the Web site with a first user information input table for registering user information of a first user, and accepting an input of the first user information input table from said user terminal of the first user;
a storing step of storing a storage unit with first registration information containing the first user information inputted to the first user information input table and containing an identifying code for identifying the first user information;
a transmitting step of transmitting, to the user terminal of the first user, the identifying code and a source program for generating a second user information input table based on in-network identifying information contained in the first user information; and
a receiving step of receiving second registration information containing user information of a second user that is inputted to the second user information input table generated based on the source program and containing the identifying code,
wherein said storing step includes storing said storage unit with the second registration information.

8. The management method according to claim 7, further comprising a managing step of managing the first registration information and the second registration information stored in said storage unit in a way that associates the first registration information and the second registration information with each other by use of the identifying code.

9. A computer readable storage medium storing an executable-by-computer program executed by a management server establishing a Web site in a network and performing communications with user terminals that access the Web site, said program comprising:
an accepting step of providing the Web site with a first user information input table for registering user information of a first user and a second user information input table for registering user information of a second user, and accepting an input of the first user information input table from said user terminal of the first user;
a storing step of storing a storage unit with first registration information containing the first user information inputted to the first user information input table and containing an identifying code for identifying the first user information; and
a transmitting step of transmitting, to the user terminal of the first user, the identifying code and address information of the second user information input table provided at the Web site based on in-network identifying information contained in the first user information,
wherein said accepting step includes accepting an input of the second user information input table from said user terminal of the second user accessing the Web site by use of the address information, and
said storing step includes storing said storage unit with second registration information containing the second user information inputted to the second user information input table and containing the identifying code.

10. The computer readable storage medium storing the program according to claim 9, further comprising a managing step of managing the first registration information and the second registration information stored in said storage unit in a way that associates the first registration information and the second registration information with each other by use of the identifying code.
